(19) United States
(12) Patent Application Publication
(10) Pub. No.: US 2007/0199584 A1
(43) Pub. Date: Aug. 30, 2007

(54) Basket For A Dishwashing Machine Having Various Receptacles And/Or Holders

(76) Inventors: Stephan Koch, Detmold (DE); Dirk Wegener, Bielefeld (DE)

Correspondence Address: FOX ROTHSCHILD LLP;PRINCETON PIKE CORPORATE CENTER, 997 LENOX DRIVE, BUILDING #3, LAWRENCEVILLE, NJ, 08648, US

(21) Appl. No.: 11/579,718

(22) PCT Filed: Apr. 19, 2005
(86) PCT No.: PCT/EP05/04145

§ 371 Date: Nov. 3, 2006

(30) Foreign Application Priority Data
May 3, 2004 (DE) 10 2004 022 024.7

(51) Int. Cl. B08B 3/00

(52) U.S. Cl. 134/135

(57) ABSTRACT

The present invention relates to a basket (1) for a dishwashing machine having various receptacles and/or holders for plates or cups whereby in particular a cup support (3) comprises a shelf pivotably mounted in the basket (1) and assuming a horizontal position to form a second supporting surface about hinge points hinge points (4, 5) provided on the basket. To increase the shelf layers of the cup support (3) the hinge points (4, 5) are mounted on the basket (1) in such a way that they are variable in height.

### FIELD OF THE INVENTION

The present invention relates to a basket for a dishwashing machine having various receptacles and/or holders for plates or cups, whereby the cup support in particular comprises a shelf pivotably mounted in the basket, assuming a horizontal position to form a second support surface about hinge points provided on the basket.

### BACKGROUND OF THE INVENTION

An upper basket is known in particular from the state of the art, for example, a dishwashing machine G 641 PLUS that is manufactured and distributed by the present applicant, said upper basket comprising a cup support on its side wall, where the cup support is pivotably mounted on the basket. Pivoting reveals a second shelf in the area of the basket for depositing cups, so that coffee cups, bowls or the like can be stacked one above the other in the basket. For example, if this cup support is also to be used for tall glasses or bowls, there is the possibility of folding up the cup support so that the entire area can be used as storage space.

With this known cup support, it is regarded as a disadvantage that the possibility of variation is limited with this pivotable cup support because only two possible shelf adjustments are possible.

### SUMMARY OF THE INVENTION

The invention is thus based on the problem of improving upon a pivotable cup support so that its shelf adjustment can be varied.

This problem is solved according to this invention by the features described in claim 1. Advantageous embodiments and refinements of the invention are derived from the following dependent claims.

The advantages that can be achieved with the present invention are derived from the fact that the hinge points about which the cup support can be pivoted allow an adjustment of the level, which results in additional levels where various utensils can be accommodated in the area of the cup support.

The hinge points are therefore guided in a molded connecting link and can be secured in various positions. To ensure dimensionally stable repositioning of the cup support, the molded connecting link comprises an essentially straight channel-like portion oriented vertically, where the hinge point can be shifted from a lower level to a higher level or set back. A curved eye-shaped portion oriented essentially horizontally is connected at each end of the vertically oriented portion, the horizontal portion being shaped and designed so that the hinge point remains engaged in this area. This provides an upper and a lower end portion in the molded connecting link in which the cup support is held pivotably and lockably.

In a preferred embodiment, noses are formed in the eye-shaped portion, extending around or behind the hinge point, and there are supporting areas in the channel-like portions against which the hinge point is supported at the rear. On the basis of this design, this provides an area in the connecting link in which the hinge point is held in a stable manner. To do so, according to a first embodiment, it is proposed that the hinge point in the molded connecting link comprises a wire loop that is connected to the cup support and is force-guided in the connecting link. The rear portion of the loop is guided exclusively in the vertically oriented portion, whereby noses are formed in the eye-shaped portion, with the front of the loop reaching around or behind the same. The rear of the loop is supported in the channel-like portion for a stable positioning of the cup support.

The hinge point as such may also comprise a pin which is guided in the connecting link, whereby the pivotably mounted cup support is connected to the pin. For assembly of the molded connecting link, it is proposed according to the present invention that the molded connecting link shall be connected to a holding plate which can be engaged between the rods forming the basket wall to secure it thereto. The connecting link and the receptacle plate may be made of a molded plastic.

### DESCRIPTION OF THE DRAWINGS

An exemplary embodiment of the invention is depicted purely schematically in the figures and is described in greater detail, showing:

FIG. 1 is a perspective view of an upper basket;

FIG. 2 illustrates a molded article in the form of a connecting link having a cup support in the first position;

FIG. 3 is another diagram according to FIG. 2 with the cup support in a second position; and

FIG. 4 is another diagram according to FIG. 2 with the cup support in a third position.

### DETAILED DESCRIPTION OF THE INVENTION

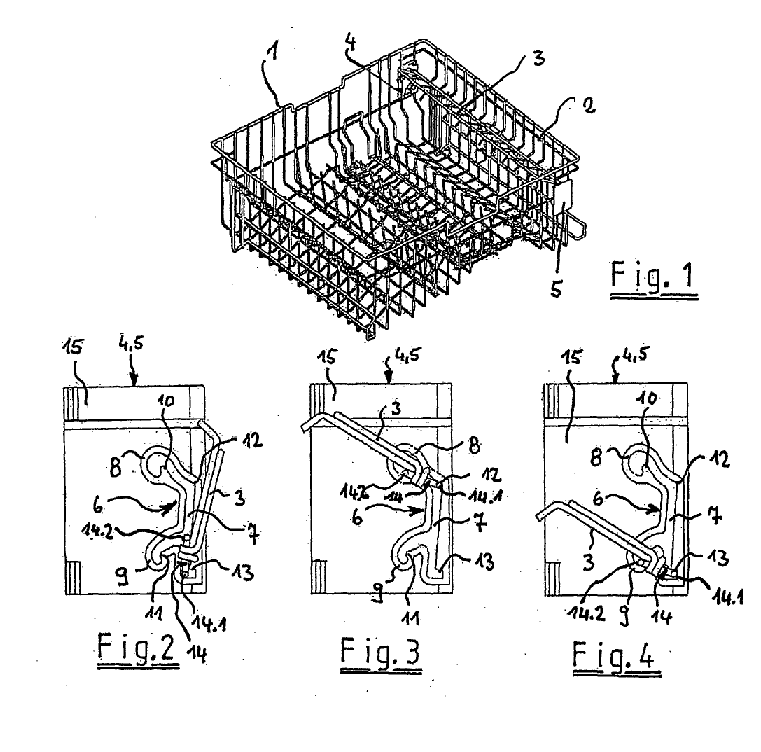

FIG. 1 shows an upper basket 1 of a dishwasher (not shown in detail here) having various receptacles and/or holders for plates and cups. As indicated in FIG. 1, a cup support 3 is provided on the side wall of the basket 1, comprising a pivotable shelf which assumes a horizontal position around hinge points 4 and 5 provided on the basket 1 to form a second supporting surface. It is self-evident that utensils designed as tall items can be placed in the basket 1 if the cup support 3 is raised.

As shown by a combined consideration of FIGS. 2 through 4 in greater detail, the hinge points 4 and/or 5 are mounted at variable heights on the basket 1 for adjusting the level of the cup support 3 in the basket 1. The hinge points 4, 5 are guided in a molded connecting link 6 so that they can be secured in various positions. For example, FIG. 2 shows a cup support 3 that has been raised, where the hinge points 4, 5 are arranged in the lower portion of the molded connecting link 6. FIG. 3 shows the positioning of the cup support 3 in the upper position in the molded connecting link 6, whereas FIG. 4 shows the lower positioning of the hinge points 4, 5 in the molded connecting link 6. As also shown by a combined consideration of FIGS. 2 through 4, the molded connecting link 6 comprises an essentially straight channel 7 oriented vertically and connected at one end to curved eye-shaped portions 8 and 9 oriented essentially horizontally and shaped and designed so that the hinge points 4, 5 can be engaged in them, as is shown clearly in FIGS. 3 and 4.

As can be seen in FIG. 2, noses 10, 11 are formed in the eye-shaped areas 8, 9, engaging around and/or behind the hinge points 4, 5, whereby supporting areas 12, 13 are provided in the channel 7 and here in the reverse area with the hinge point 4, 5 supported against the supporting areas at the back.

To do so, according to a first embodiment, it is preferred that the hinge point 4, 5 in the molded connecting link 6 comprises a wire loop 14 which is connected to the cup support 3 and is forcibly guided in the connecting link 6. The rear portion 14.1 of the loop 14 is guided exclusively in the channel 7 that runs vertically, whereby noses 10 and 11 are formed in the eye-shaped portions 8 and 9, with the front portion 14.2 of the loop reaching around and/or behind said noses. The rear loop portion 14.1 is supported in the channel 7 for stable positioning of the cup support 3.

The hinge points 4, 5 may also comprise a pin which is guided in the connecting link 6, the cup support 3 being designed as wire mesh connected to the pin.

It is self-evident if, for example, the cup support 3 is to be brought from the position shown in FIG. 3 to the position shown in FIG. 2, the cup support 3 need only be pivoted upward, so that the loop 14 can be brought into the raised position along the connecting link. If the positioning in FIG. 4 is to be reached, one need only pivot the cup support 3 forward, so that the nose 10 engages behind loop 14, whereby the loop 14 is supported on the supporting area 13 on a portion of the connecting link 6, thus resulting in a stable position for the cup support 3.

The molded connecting link 6 is preferably attached to a receptacle plate 15 which can be engaged between the rods forming the basket wall to secure it (easier to see in FIG. 1). This provides a stable mounting for the molded connecting link 6 which allows the various positions of the cup support 3. The connecting link 6 and the receptacle plate 15 may be made of a molded plastic.

It is self-evident that in the case of a divided cup support, hinge points 4, 5 are provided accordingly on the ends of the divided cup support.

1-7. (canceled)

8. A basket for a dishwashing machine having various receptacles and/or holders for plates or cups, the basket comprising a cup support that is pivotably mounted in the basket and assumes a horizontal position to form a second supporting surface at hinge points mounted on the basket, the hinge points being mounted on the basket such that the hinge points are variable in height for adjusting the level of the cup support shelf, wherein the hinge points are slidably guidable in a molded connecting link and can be secured in various positions, the molded connecting link comprising a channel, the channel having an essentially straight channel portion oriented vertically and developing at each end into a curved eye-shaped channel portion that is oriented essentially horizontally and is shaped such that the hinge points engage therein.

9. A basket according to claim 8, wherein the hinge points comprise a wire loop disposed in the molded connecting link, said wire loop being connected to the cup support and guidable in the channel of connecting link, wherein the rear portion of the loop is guidable exclusively in the vertically oriented portion of the channel.

10. A basket according to claim 9, wherein the hinge points comprise a loop and the curved eye-shaped channel portions comprise a nose over which the front portion of the loop may be engaged, and the channel comprises supporting areas against which the rear portion of the loop may be supported.

11. A basket according claim 8, wherein the hinge points comprise a pin which is guidable in the channel of the connecting link and the cup support is connected to the pin.

12. A basket according claim 9, wherein the hinge points comprise a pin which is guidable in the channel of the connecting link and the cup support is connected to the pin.

13. A basket according claim 10, wherein the hinge points comprise a pin which is guidable in the channel of the connecting link and the cup support is connected to the pin.

14. A basket according to claim 8, wherein the molded connecting link is connected to a receptacle plate which can be engaged between rods forming the basket wall to secure it thereto.

15. A basket according to claim 9, wherein the molded connecting link is connected to a receptacle plate which can be engaged between rods forming the basket wall to secure it thereto.

16. A basket according to claim 10, wherein the molded connecting link is connected to a receptacle plate which can be engaged between rods forming the basket wall to secure it thereto.

17. A basket according to claim 11, wherein the molded connecting link is connected to a receptacle plate which can be engaged between rods forming the basket wall to secure it thereto.

18. A basket according to claim 8, wherein the connecting link and the receptacle plate are made of a molded plastic.

19. A basket according to claim 9, wherein the connecting link and the receptacle plate are made of a molded plastic.

20. A basket according to claim 10, wherein the connecting link and the receptacle plate are made of a molded plastic.

21. A basket according to claim 11, wherein the connecting link and the receptacle plate are made of a molded plastic.

22. A basket according to claim 8, wherein, when a divided cup support is used, hinge points are provided on the ends of the divided cup support.
